(19) United States
(12) Patent Application Publication
(10) Pub. No.: US 2012/0000133 A1
(43) Pub. Date: Jan. 5, 2012

(54) Method for Operating a Motor-Drive Device for a Home Automation Installation Comprising a Shutter Provided with Two Leaves

(75) Inventor: Clément Rohee, Perruel (FR)

(73) Assignee: Somfy SAS, Cluses (FR)

(21) Appl. No.: 13/167,375

(22) Filed: Jun. 23, 2011

(30) Foreign Application Priority Data
Jun. 25, 2010 (FR) 10 55073

(51) Int. Cl. E05F 15/02; G05B 15/02; E06B 7/086

(52) U.S. Cl. 49/358; 49/506; 700/275

(57) ABSTRACT

Method for operating a motor-drive device (1) for a home automation installation (100) comprising a closure, blackout, solar protection, thermal protection or sound protection shutter (5a, 5b) provided with a first leaf (5a) and a second leaf (5b), the motor-drive device (1) including an electronic unit for controlling a first motor (Ma) and a second motor (Mb), the first motor moving the first leaf between two extreme positions and the second motor moving the second leaf between two extreme positions. The method comprises a step for powering the first and second motors so that the first and second leaves are in an intermediate position that is symmetrical relative to a vertical plane of symmetry (S) of the installation.

This application claims priority benefits of French Patent Application Number 10 55073 filed Jun. 25, 2010, the enclosure of which is herein incorporated by reference.

The invention relates to the field of thermal and solar protection screens in buildings, in particular casement shutters. These shutters are used, depending on their position of deployment, to stop all or part of the solar radiation through the openings of the building, notably in summer, and conversely, to avoid heat losses to the outside by forming a thermal barrier in winter and in particular at night. They can be positioned manually or by motor drive.

There are many motor-drive solutions for managing particular open, closed or intermediate positions for windable screens, for example roller blinds or shades.

Moreover, it is known in the field of swinging gates to make it possible to open just one of the leaves, to allow passage for a pedestrian, a cyclist, without requiring all of the door to be fully opened. The single leaf concerned is then the main leaf.

In the field of casement shutters, it is also desirable to have an intermediate positioning function, making it possible to allow air to pass while blacking out part of the light radiation toward the interior of the residence. This intermediate position is not available on motor-drive systems with mechanical offset. From the existing motor-drive devices with two motors, the only intermediate position available is that of a stop at full travel. In addition to the fact that it is not easily reproducible, it is difficult to obtain a harmonious intermediate position, the two leaves being often offset when stopped in this way.

For casement shutters, it is known to use either one motor for each swinging leaf, or a single motor for a set of two leaves. In all cases, the solutions of the prior art define offsets for the movements of the two leaves, usually mechanical offsets.

In fact, the shutters have to be closed or opened in a particular order, because of their asymmetry and because of the presence of a joint cover strip, that is to say, a part of one leaf overlapping the other when the casement shutter is closed. Generally, an offset in time is provided between the beginning of the movement of a main leaf (the one including the joint cover strip) and the beginning of the movement of the secondary leaf. Thus, on opening, the so-called main leaf is opened first, on closure, the secondary leaf is closed first.

For leaf shutter systems with a single motor, a mechanical device (spring-operated) is used to begin the movement of the second leaf with an offset in time with respect to the movement of the first leaf. In the case of an installation with two motors, this offset is produced by the wiring of a so-called main motor for the main leaf and a so-called secondary motor for the secondary leaf.

There is therefore a need for a simple solution that does not introduce extra cost to easily obtain a partially open position for the shutters which is harmonious. It is also desirable to easily obtain a partially open position which offers the maximum wind resistance. It is also desirable for this intermediate position to be able to be controlled by a simple command from an open or closed position, or even from any current position of the shutters at the moment of the command.

The document FR 2741651 discloses a motor-driven leaf shutter system. It makes it possible to provide offsets for the leaves during opening and during closure, that is to say suitable time delays to ensure the correct execution of the movements of the two leaves.

The documents EP 0 484 258 and EP 1 674 647 disclose a motor-driven leaf shutter system.

Finally, the document DE 3935 173 discloses a motor-driven leaf door system.

None of these documents provides a solution to the issue described previously.

The aim of the invention is to provide an operating method that addresses the above drawbacks and that improves known prior art methods. In particular, the invention provides an operating method that makes it possible, inexpensively, to simplify the configuration of a home automation installation comprising two motor-driven leaves. The invention also relates to a motor-drive device for a home automation installation comprising two motor-driven leaves, such that an intermediate position that meets the objectives described above can be obtained.

The method according to the invention relates to the operation of a motor-drive device for a home automation installation comprising a closure, privacy, solar protection, thermal protection or sound protection shutter provided with a first movable leaf and a second movable leaf. The motor-drive device includes an electronic unit for controlling a first motor and a second motor. The first motor moves the first leaf between two extreme positions and the second motor moves the second leaf between two extreme positions. The method comprises a step for powering the first and second motors so that the first and second leaves are in an intermediate position that is symmetrical relative to a vertical plane of symmetry of the installation.

The first leaf may be a main leaf or a secondary leaf.

The method may comprise a configuration phase including:
a step for the displacement of the first leaf to a provisional intermediate position,
a step for the determination of an intermediate position parameter from the current position of the first leaf,
a step for the definition of a final intermediate position relative to the first leaf from the intermediate position parameter and of a final intermediate position relative to the second leaf from the intermediate position parameter.

The step for the definition of the final intermediate positions may comprise a step for assigning the intermediate position parameter to define the final intermediate position of the first leaf and to define the final intermediate position of the second leaf.

The intermediate position parameter may be a time of activation of the first motor or a value obtained by counting, during a displacement of the first leaf from a reference position to the provisional intermediate position.

The step for the definition of a final intermediate position for each of the two leaves from the intermediate position parameter may allow for the replacement of another intermediate position previously defined for each of the two leaves.

The final intermediate position may be a position of synchronization and/or of desynchronization of the movement of the leaves.

To reach the final intermediate position, the first and second motors may be activated according to a sequence comprising a time offset between the activation of the first motor and of the second motor.

The final intermediate position may be identical regardless of the starting position of the leaves (open, closed, partially open) at the moment of the start of an execution of a movement command.

There may be a number of final intermediate positions that can be reached for one and the same installation.

The device according to the invention makes it possible to motorize a home automation installation comprising a closure, blackout, solar protection, thermal protection or sound protection shutter provided with a first leaf and a second leaf. The motor-drive device includes an electronic unit for controlling a first motor and a second motor, a remote control point linked to the electronic unit. The first motor moves the first leaf between two extreme positions and the second motor moves the second leaf between two extreme positions. The device comprises hardware and/or software means for implementing the method defined previously.

The home automation installation according to the invention comprises a motor-drive device defined previously. It comprises, in an intermediate position, notably a stop intermediate position, a configuration in which the two leaves are in a symmetrical position relative to a vertical plane of symmetry of the installation.

The stop position may be a predefined position.

The stop position may be a position defined by learning.

The invention also relates to a computer program comprising a computer program code means suitable for performing the steps of the method defined previously, when the program is run on a computer.

The invention also relates to a data storage medium that can be read by a computer on which is stored a computer program comprising software means for implementing the steps of the method defined previously.

The invention will be better understood on reading the following description, given solely as an example and with reference to the appended drawings in which:

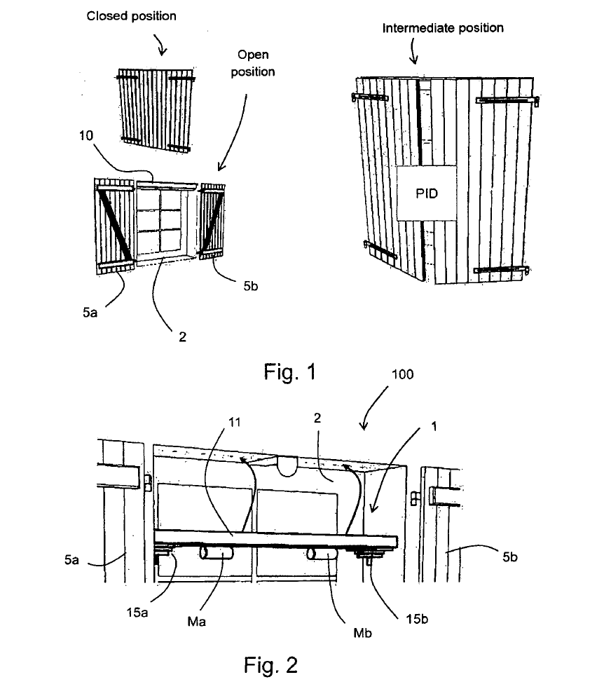

FIG. 1 is a view of an embodiment of a home automation installation according to the invention, shown closed, open and in an intermediate position.

FIG. 2 is a view of an embodiment of a motor-drive device according to the invention being installed in an opening of a building.

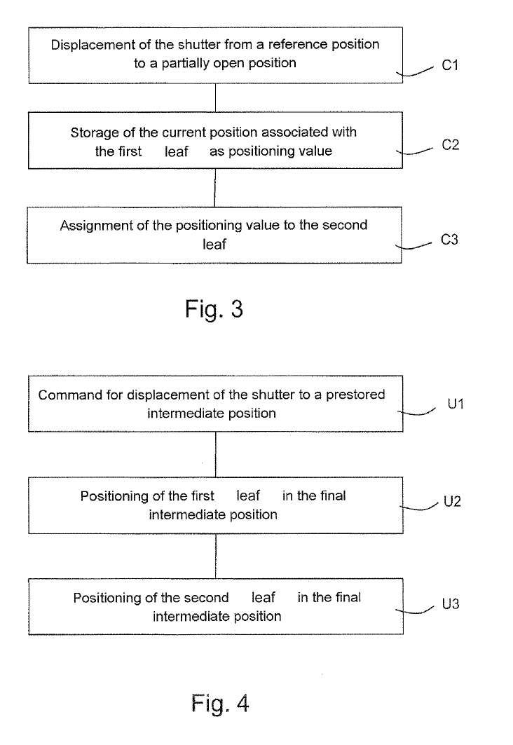

FIG. 3 is a flow diagram of a method of executing a first procedure of the operating method according to the invention.

FIG. 4 is a flow diagram of a method of executing a second procedure of the operating method according to the invention.

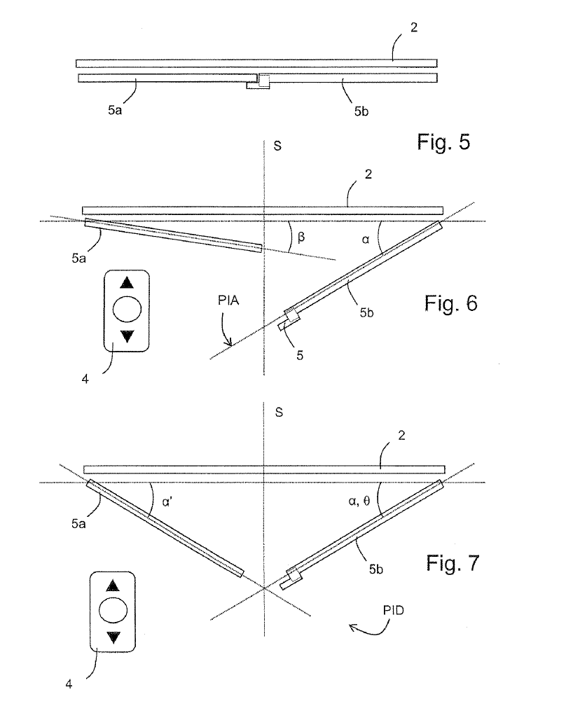

FIG. 5 is a schematic view of a home automation installation according to the invention in the closed position.

FIG. 6 is a schematic view of a home automation installation according to the invention during opening or closure.

FIG. 7 is a schematic view of a home automation installation according to the invention in an intermediate position.

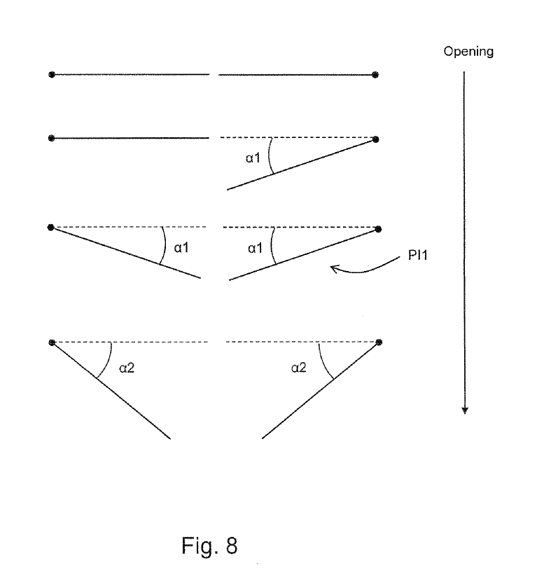

FIG. 8 is a schematic view of a home automation installation during an opening sequence.

FIG. 1 shows a leaf shutter home automation installation 100 according to the invention installed in a window 2 of a building. The installation comprises a motor-drive device 1. The window is equipped with a shutter consisting of two leaves 5a and 5b that can pivot so as to cover the window or to leave said window uncovered, as represented in this figure. The leaf shutter installation is represented in the extreme open position, in the extreme closed position and in a symmetrical intermediate position in accordance with the invention.

The motor-drive device comprises a housing. This is shown open in FIG. 2, which shows the motor-drive device being mounted at the time of its installation in the window casement. The device consists of a base 11 supporting a first motor Ma and a second motor Mb. It also supports an electronic unit to which the motors are linked. Mechanical transmission means, notably gear transmission means, are used to transmit the movements caused by the motors on the leaves. These transmission means are located towards the ends of the base.

The methods described below apply equally to an installation controlled by other motor-drive devices, for example comprising motors driving the movement of the shutters at the level of their hinges.

According to a first embodiment, an electronic unit of the motor-drive device, not represented, controls the activation of the two motors according to a sequence comprising a time offset, between the activation of the first motor and of the second motor: on a command to open the two leaves, the main motor Mb is the motor that is activated first, the secondary motor Ma being activated with a time offset To relative to the secondary motor, whereas, on closure, the main motor Mb is activated second, with a time offset Tf relative to the secondary motor Ma, the offsets on opening and on closure being able to be equal or different. The motor Mb is the motor associated with the main leaf, because of the presence of a joint cover strip 5 on the main leaf 5b associated with the first motor Mb, and the motor Ma is the motor associated with the secondary leaf 5a.

Each leaf is therefore displaced between an extreme closed position and an extreme open position. The positions may be identified by counting or measuring a displacement of the arms, a movement of the gear or a rotation of the corresponding motor, or by time management of the displacement. The offset between the movement of the two leaves may also be initiated from a counting measurement (for example, opening of the secondary leaf after a measurement of a predefined number of turns on the motor controlling the main leaf) or equally by time. It is managed by the electronic unit which is common to both motors.

The time offset between the activation of the motors corresponding to the two leaves may also be set to an operating time, or in the case of an installation with a counting device, it may be equivalent to the time of movement (or of activation of the motor) to a predefined position of the associated leaf or to the time of rotation by a predefined angle.

A remote control unit 4 is used to command the opening, closure, stop or intermediate positioning movements of the shutter. This remote control unit is linked to the electronic unit by a wired or wireless link, for example by electromagnetic waves, via which it controls the operations of the actuators. It also makes it possible to give storage instructions to the electronic unit, for example to store a current position of one of the leaves.

The motor-drive device according to the invention, in particular the electronic unit, comprises hardware and/or software means governing the operating method according to the invention, that is to say, comprising hardware and/or software means for implementing the steps of the operating method according to the invention. In particular, the hardware and/or software means comprise control means for powering the motors, a first memory for storing at least one intermediate position parameter relating to the first leaf, a second memory for storing at least one intermediate position parameter relating to the second leaf and, optionally, a duplication means for copying, into the second memory, a parameter contained in the first memory. The software means may comprise computer programs.

A method of executing the configuration method according to the invention is described hereinbelow with reference to FIG. 3. In particular, it makes it possible to configure a motor-drive device as described previously.

In a first step C1, the shutter is displaced from a known reference position (in this example, from an extreme closed position), as represented in FIG. 5, to a first partially open position or provisional intermediate position PIA represented in FIG. 6 and approximately corresponding to the desired final intermediate position. This displacement may be caused by a shutter movement command followed by a stop in the chosen position, from the remote control unit.

In practice, it is sufficient for a first of the two leaves to be displaced to the provisional intermediate position PIA. This first leaf is called reference leaf. The second leaf may optionally not be displaced.

During a second step C2, the position of the reference leaf, represented by the angle α, is stored as intermediate position parameter used as a basis for calculating the final intermediate position PID of the shutter and defined by final intermediate positions of the two leaves.

In an alternative embodiment, the intermediate position parameter is calculated from the current position α of the reference leaf and the current position β of the symmetrical leaf during the storage step. Thus, the intermediate position parameter can be determined on the basis of a weighted command law based on the positions of the two leaves during this storage step. For example, the intermediate position parameter may be defined by an angle θ=½(α+β).

During a third step C3, an intermediate position parameter α′ is then also assigned to the second leaf, called symmetrical leaf. This step makes it possible to define the final intermediate position PID of the shutter.

In a first preferred alternative, the reference leaf is the main leaf.

Alternatively, it is the second leaf. In this case, the only intermediate position parameter stored during the step C2 is the one associated with the secondary leaf.

For example, the intermediate position parameter assigned to the symmetrical leaf is equal to the intermediate position parameter stored for the reference leaf: it is therefore (very probably) different from the current intermediate position parameter of the symmetrical leaf at the configuration time, represented by the angle β in FIG. 6. Thus, the provisional intermediate position of the symmetrical leaf (represented by the angle β) is a priori different from the final intermediate position of the symmetrical leaf (defined by the intermediate position parameter which is assigned to the symmetrical leaf and represented by the angle α′). Preferably, the intermediate position parameter is used as such to define the final intermediate position of the reference leaf. Thus, the final and provisional intermediate positions of the reference leaf are the same.

The intermediate position parameter may correspond to a position defined by counting, that is to say, to a position index in the relative travel between the extreme positions. It may alternatively correspond to a time of travel from a reference position, for example an extreme position, the time of travel from the other extreme position being able to be deduced from the former by subtraction from the total time of travel between the extreme positions. It may also be defined by an angle of rotation or by a percentage of the total travel between the extreme positions.

The intermediate position parameter stored or assigned to each leaf is such that it can be reached in operation from a known open or closed position, possibly by calculation or conversion. This known open or closed position is not necessarily an extreme position, but it is reliably identified.

These configuration steps may take place in a configuration mode or during a usage mode of the leaf shutter, by a predefined storage procedure. It is preferable for the storage and the controlling of such a final intermediate position to be able to be performed as simply as possible, as is the case for roller blinds for example, by a brief or prolonged press on a stop key (when the motors are already stopped) or any other key dedicated or not dedicated to the final intermediate position, or by a combination of presses.

The intermediate position parameter stored for the reference leaf is independent of the time offset for beginning the movements of the two leaves. However, it is preferable for this intermediate position parameter to define a position of the two leaves situated outside the offset range on opening or on closure. In other words, it is necessary, on opening, for the main leaf to be sufficiently open for the movement of the secondary leaf to begin, or on closure, for the secondary leaf to be sufficiently closed for the movement of the main leaf to begin, before being able to store the final intermediate position, in order to avoid blocking situations in operation. In fact, in operation, it may be that the main or secondary leaf covers more or less travel than during the configuration movement. In this case, there is a risk of collision between the two leaves.

These conditions are automatically fulfilled when the configuration implements a step for positioning the two leaves in provisional intermediate positions.

It is also preferable to implement the above configuration method on the basis of a reference position in which the leaves are symmetrical relative to the plane of symmetry S of the window. This is generally the closed position case. It may be that, in an open position, because of the presence of an obstacle or of a wall, the leaves are not in a symmetrical position. However, similarly, the steps described above could be performed from the extreme open position as the reference position.

A method of executing the control method according to the invention is described hereinbelow with reference to FIG. 4. It notably makes it possible to govern the operation of a motor-drive device as described previously, this device having previously been configured in accordance with the configuration method according to the invention.

In a first step U1, the user commands a displacement of the shutter to the final intermediate position.

During a second step U2, the scenario for movement to the final intermediate position for each of the two shutters is then defined according to the starting position of the leaves or the movement (opening, closure) to be performed to reach this final intermediate position.

In fact, the movement to be performed for each of the leaves is dependent on the intermediate position parameter and on the time offset provided between the movements of the main and secondary leaves.

The scenarios for movement to a final intermediate position may be different depending on whether this final intermediate position is reached in opening or closure operation. Preferably, the offset observed between the leaves during an opening or closure command is retained when it is a command to move to a final intermediate position.

This example describes the positioning in final intermediate position from a closed position of the shutter, the reference leaf being the main leaf. In a command for final intermediate positioning from the closed position, the main leaf begins its movement towards the position corresponding to the intermediate position parameter stored during the configuration of the installation. After a time offset TIo, the movement of the secondary leaf begins. The secondary leaf is driven to the position corresponding to the intermediate position parameter that was assigned to it.

During the transition from the open position to the final intermediate position, the secondary leaf is displaced first to reach its position, defined by the configuration. After a closure time offset TIf, the main leaf begins its movement and is also displaced to the position defined by the configuration. At the end of the movement of the two leaves, they have covered a travel conforming to the positioning parameters that were assigned to them and are in the final intermediate position, in a symmetrical configuration relative to the plane of symmetry S of the window or of the installation.

It is also possible to reach the final intermediate position for the two leaves from any stop position along complete travel. In this case, the movement imparted on the two leaves takes into account the movements already counted during previous movements performed from an extreme position. The opening and closure time offsets are retained for each new movement, regardless of the previous movements of the leaves and of the offsets already counted from an extreme position. Alternatively, the offsets already counted may be taken into account.

In a preferred exemplary embodiment, the opening time offset To is 1 second between the opening movement of the main leaf and the opening of the secondary leaf. The closure time offset is 3 seconds between the closure movement of the secondary leaf and the closure movement of the main leaf. The opening and closure offsets are therefore different. Time offsets different from those corresponding to an opening and/or closure command could also be implemented in a command to a final intermediate position. This would make it possible to manage the movement more harmoniously to the final intermediate position. Advantageously, all these offsets are adjustable.

The above description mentions the displacements of the leaves to particular positions. These displacements are controlled via the associated motors and said final intermediate positions and position parameters are stored and managed by the electronic unit controlling the motors.

It is also possible, via the electronic unit controlling both motors, to reverse the direction of priorities of the leaves if necessary, that is to say, to modify the time offsets between the actuation of the first motor and of the second motor, so that these offsets correspond to a correct closure of the shutter (the leaf with the joint cover strip being opened first and closed second).

Advantageously, a predefined intermediate position may be prestored and used as a final intermediate position without there being a need to configure the latter in accordance with the method described. This predefined intermediate position comprises, for example, an intermediate position parameter representing a percentage of the travel of a reference leaf, for example of the main leaf. During operation, the total travel of the reference leaf between the extreme positions is determined and the predefined intermediate position for the two leaves is deduced from this total travel value. The predefined intermediate position may be, for example, equal to 20% of the total travel from the closed position.

This predefined intermediate position is replaced by the final intermediate position once the latter is configured by the user.

According to a second exemplary embodiment of the leaf shutter motor-drive device schematically represented in FIG. 8, the opening and closure operation of the leaves is differentiated from the prior art by the offset sequence provided between the movement of the main leaf and of the secondary leaf.

On opening, the main leaf begins its movement to a predefined open position (angle α1) at which it stops. The movement of the secondary leaf then begins until reaching a position PI1 that is symmetrical to that of the main leaf (identical angle α1). The movement of the main leaf then resumes and the two leaves open in a synchronized manner, that is to say symmetrically or by forming, at any moment, substantially the same opening angle, until at least one of the leaves reaches its extreme open position. The position in which the leaves are in a symmetrical position PI1 corresponds to a synchronization position.

On closure, similarly, the movement of the two leaves begins at the same time and the two leaves are moved in a synchronized manner, that is to say symmetrically or by forming, at any moment, substantially the same angle of opening, until the leaves reach a common position of desynchronization. The movement of the main leaf then stops and the secondary leaf continues its movement to its closed position. The main leaf is then also closed.

The positions of synchronization and of desynchronization therefore correspond to symmetrical intermediate positions. These are defined by construction and do not necessarily have to be configured by a user. Alternatively, the configuration of an intermediate position as defined in the first embodiment could be used as a basis for these positions of synchronization/desynchronization.

Advantageously, the positions of synchronization and of desynchronization are two distinct positions, which makes it possible to define for the leaf shutter device two distinct intermediate positions.

Throughout this document, the term “intermediate position” designates any position of the shutter or of the leaves in which neither of the leaves is in an extreme position or an end-of-travel position or is not substantially in an extreme position or an end-of-travel position.

Throughout this text, the term “symmetrical” should be understood to mean “symmetrical” or “substantially symmetrical”, that is to say in which an absolute value of the difference in opening angle of the two leaves is less than 10°, preferably less than 5°.

1. Method for operating a motor-drive device (1) for a home automation installation (100) comprising a closure, privacy, solar protection, thermal protection or sound protection shutter (5a, 5b) provided with a first leaf (5a) and a second leaf (5b), the motor-drive device (1) including an electronic unit for controlling a first motor (Ma) and a second motor (Mb), the first motor moving the first leaf between two extreme positions and the second motor moving the second leaf between two extreme positions, wherein the method comprises a step for powering the first and second motors so that the first and second leaves are in an intermediate position that is symmetrical relative to a vertical plane of symmetry (S) of the installation.

2. Operating method according to claim 1, wherein the first leaf is a main leaf or a secondary leaf.

3. Operating method according to claim 1, wherein the method comprises a configuration phase including:
a step for the displacement of the first leaf to a provisional intermediate position,
a step for the determination of an intermediate position parameter from the current position of the first leaf,
a step for the definition of a final intermediate position relative to the first leaf from the intermediate position parameter and of a final intermediate position relative to the second leaf from the intermediate position parameter.

4. Operating method according to claim 3, wherein the step for the definition of the final intermediate positions comprises a step for assigning the intermediate position parameter to define the final intermediate position of the first leaf and to define the final intermediate position of the second leaf.

5. Operating method according to claim 3, wherein the intermediate position parameter is a time of activation of the first motor or a value obtained by counting, during a displacement of the first leaf from a reference position to the provisional intermediate position.

6. Operating method according to claim 4, wherein the intermediate position parameter is a time of activation of the first motor or a value obtained by counting, during a displacement of the first leaf from a reference position to the provisional intermediate position.

7. Operating method according to claim 3, wherein the step for the definition of a final intermediate position for each of the two leaves from the intermediate position parameter allows for the replacement of another intermediate position previously defined for each of the two leaves.

8. Operating method according to claim 3, wherein the final intermediate position is a position of synchronization and/or of desynchronization of the movement of the leaves.

9. Operating method according to claim 3, wherein, to reach the final intermediate position, the first and second motors are activated according to a sequence comprising a time offset (TIo, TIf) between the activation of the first motor and of the second motor.

10. Operating method according to claim 3, wherein the final intermediate position is identical regardless of the starting position of the leaves (open, closed, partially open) at the moment of the start of an execution of a movement command.

11. Operating method according to claim 3, wherein there are a number of final intermediate positions that can be reached for one and the same installation.

12. Data storage medium that can be read by a computer on which is stored a computer program comprising software means for implementing the steps of the method according to claim 1.

13. Motor-drive device (1) for a home automation installation (100) comprising a closure, privacy, solar protection, thermal protection or sound protection shutter (5a, 5b) provided with a first leaf (5a) and a second leaf (5b), the motor-drive device (1) including an electronic unit for controlling a first motor (Ma) and a second motor (Mb), a remote control point (4) linked to the electronic unit, the first motor moving the first leaf between two extreme positions and the second motor moving the second leaf between two extreme positions, wherein the device comprises hardware and/or software means for implementing the method according to claim 1.

14. Home automation installation (100) comprising a motor-drive device according to claim 13, wherein the installation comprises, in an intermediate position, notably a stop intermediate position, a configuration in which the two leaves are in a symmetrical position relative to a vertical plane of symmetry (S) of the installation.

15. Home automation installation according to claim 14, wherein the stop position is a predefined position.

16. Home automation installation according to claim 14, wherein the stop position is a position defined by learning.

17. Home automation installation according to claim 15, wherein the stop position is a position defined by learning.
